(19) United States
(12) Patent Application Publication
(10) Pub. No.: US 2011/0085588 A1
(43) Pub. Date: Apr. 14, 2011

(54) METHOD FOR PRECODING BASED ON ANTENNA GROUPING

(75) Inventors: Xiangyang Zhuang, Lake Zurich, IL (US); Tyler A. Brown, Mundelein, IL (US)

(73) Assignee: MOTOROLA-MOBILITY, INC., Libertyville, IL (US)

(21) Appl. No.: 12/899,211

(22) Filed: Oct. 6, 2010

Related U.S. Application Data
(60) Provisional application No. 61/250,408, filed on Oct. 9, 2009.

(51) Int. Cl. H04L 27/00; H04B 1/38

(52) U.S. Cl. 375/219; 375/295

(57) ABSTRACT

A method an apparatus for performing uplink transmission in a user device with a plurality of transmit antennas, including transmitting a first data stream from a first subset of the antennas according to a first precoding vector wherein the first precoding vector may be any vector in a precoding codebook, and transmitting a second data stream from a second subset of the antennas according to a second precoding vector wherein any vector in the precoding codebook may be used for the second precoding vector when the second precoding vector is the same as the first precoding vector to within a scaling factor.

### CROSS REFERENCE TO RELATED APPLICATIONS

The present application is a non-provisional application of U.S. provisional Application No. 61/250,408 filed on 9 Oct. 2009, the contents of which are incorporated by reference herein and from which benefits are claimed under 35 U.S.C. 119.

### FIELD OF THE DISCLOSURE

The present disclosure relates generally to wireless communications and more particularly to a multi-antenna precoding transmission based on antenna grouping in a wireless communication system.

### BACKGROUND

The Third Generation Partnership Project (3GPP) is developing a Long Term Evolution (LTE) standard using a physical layer based on globally applicable evolved universal terrestrial radio access (E-UTRA). In release-8 specification of LTE, an LTE base station, referred to as an enhanced Node-B (eNB) or base unit, may use an array of four antennas to receive a signal from a piece of user equipment (UE) or wireless terminal. It is envisioned that improved uplink throughput and spectral efficiency may be obtained once a wireless terminal is equipped with multiple antennas that make it possible to use many multi-antenna transmission schemes. Examples of multi-antenna transmission include transmit diversity, open-loop, and closed-loop with single or multiple transmission layers (streams of data). The choice of an optimal transmission scheme depends on characteristics of the uplink channel including signal-to-noise ratio (SNR), channel rank, channel covariance structure, and other characteristics. These quantities vary between users in the system and over the duration of a data session. The uplink scheme may be determined by the eNB that conveys the scheme to the UE via control signaling, as part of the uplink resource allocation information.

For user devices equipped with multiple transmit antennas, antenna precoding is an effective means of transmission to improve the link quality. Depending on different channel conditions, the eNB instructs the UE on how its multiple antennas are used in the uplink transmission by, in the case of precoding, applying a different weighting and phase offset to each of the transmit antennas.

The various aspects, features and advantages of the disclosure will become more fully apparent to those having ordinary skill in the art upon a careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates a wireless communication system according to a possible embodiment;

FIG. 2 illustrates a wireless terminal communicating with a base unit according to a possible embodiment;

FIG. 3 illustrates several possible ways of grouping transmit antenna elements, using 4 transmit antenna as an example;

FIG. 4 illustrates a flowchart according to a possible embodiment for a user device transmitting a first and a second data stream;

FIG. 5 illustrates a flowchart according to a possible embodiment; for a base station to indicate a first and a second precoding vector.

### DETAILED DESCRIPTION

The embodiments include a method for performing uplink transmission in a user device with a plurality of transmit antennas, the method comprising: transmitting a first data stream from a first subset of the plurality of transmit antennas according to a first precoding vector, wherein the first precoding vector may be any vector in a precoding codebook; transmitting a second data stream from a second subset of the plurality of transmit antennas according to a second precoding vector, wherein any vector in the precoding codebook may be used for the second precoding vector when the second precoding vector is the same as the first precoding vector to a scaling factor (i.e., proportional).

The embodiments further include a method in a base station, the method comprising: indicating to a user device a first precoding vector selected from a precoding codebook, wherein the first precoding vector is for a first subset of a plurality transmit antennas of the user device; indicating to the user device a second precoding vector, wherein the second precoding vector is for a second subset of a plurality transmit antennas of the user device; and wherein any vector in the precoding codebook may be used for the second precoding vector when the second precoding vector is the same as the first precoding vector to a scaling factor.

The embodiments further include a wireless terminal comprising: a plurality of transmit antennas; a plurality of transceivers coupled to the plurality of transmit antennas; a precoding module coupled to the plurality of transceivers, the precoding module weights a first data stream according to a first precoding vector, wherein the first data stream is transmitted from a first subset of transmit antennas and the first precoding vector may be any vector in a precoding codebook; the precoding module weights a second data stream according to a second precoding vector, wherein the second data stream is transmitted from a second subset of transmit antennas and wherein any vector in the precoding codebook may be used for the second precoding vector when the second precoding vector is the same as the first precoding vector to within a a scaling factor.

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure comprises a variety of embodiments, such as a method, an apparatus, and an electronic device, and other embodiments that relate to the basic concepts of the disclosure. The electronic device may be any manner of computer, mobile device, or wireless communication device.

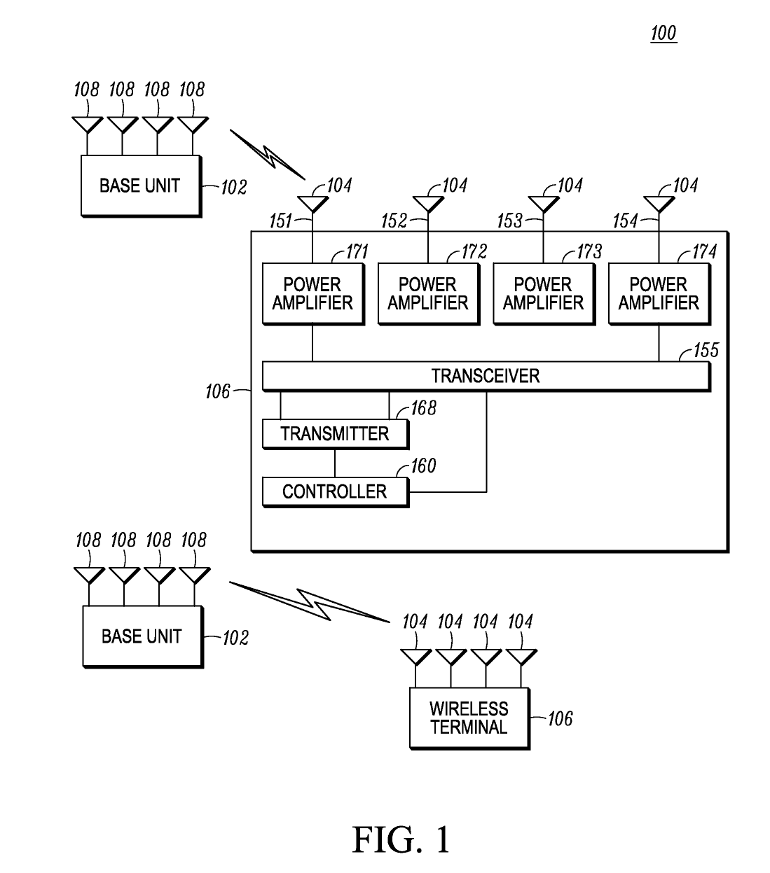

In FIG. 1, a wireless communication system 100 can comprise one or more fixed base infrastructure units 102 forming a network distributed over a geographical region for serving wireless terminals 106 in the time and/or frequency domain. A base unit 102 may also be referred to as an access point, access terminal, base, base station, Node-B, eNode-B, Home Node-B, Home eNode-B, relay node, or by other terminology used in the art. The one or more base units 106 each can include one or more antennas 108, each of which may be used for transmission of communication signals, reception of communication signals, or both transmission and reception of communication signals. The base units 102 are generally part of a radio access network that can include one or more controllers communicably coupled to one or more corresponding base units 102. The access network is generally communicably coupled to one or more core networks, which may be coupled to other networks, like the Internet and public switched telephone networks, among other networks. These and other elements of access and core networks are not illustrated but are well known generally by those having ordinary skill in the art.

In FIG. 1, the one or more base units 102 can serve a number of wireless terminals 106, within a corresponding serving area, for example, a cell or a cell sector, via a wireless communication link. The wireless terminals 106 may be fixed or mobile. The wireless terminals 106 may also be referred to as subscriber units, mobiles, mobile stations, users, terminals, subscriber stations, user equipment (UE), user terminals, wireless communication devices, user devices, or by other terminology used in the art. In FIG. 1, the base unit 102 transmits downlink communication signals to serve wireless terminal 106 in the time and/or frequency and/or spatial domain. The wireless terminal 106 communicates with base unit 102 via uplink communication signals. The wireless terminal 106 can include one or more antennas 104 each of which may be used for transmission of communication signals, reception of communication signals, or both transmission and reception of communication signals. The wireless terminals 106 may transmit in have half duplex (HD) or full duplex (FD) mode. In Half-duplex transmission and reception do not occur simultaneously whereas in full duplex transmission terminals do transmission and reception do occur simultaneously. The wireless terminals 106 may communicate with the base unit 102 via a relay node.

In one implementation, the wireless communication system 100 is compliant with the 3rd Generation Partnership Project (3GPP) Universal Mobile Telecommunications System (UMTS) Long Term Evolution (LTE) protocol, also referred to as Evolved Universal Mobile Telecommunications System (UMTS) Terrestrial Radio Access (EUTRA) or Release-8 (Rel-8) 3GPP LTE or some later generation thereof, wherein the base unit 102 transmits using an orthogonal frequency division multiplexing (OFDM) modulation scheme on the downlink and the user terminals 106 transmit on the uplink using a single carrier frequency division multiple access (SC-FDMA) scheme. More generally, however, the wireless communication system 100 may implement some other open or proprietary communication protocol, for example, WiMAX, among other protocols.

According to one embodiment, the wireless terminal 106 can include a plurality of antennas 151, 152, 153, and 154 for example, coupled to power amplifier 171, 172, 173, and 174, respectively. The wireless terminal 106 can include transceiver 155 coupled to the plurality of power amplifiers 171, 172, 173, and 174. While a transceiver architecture with one RF front end may be used for antenna switching, another typical architecture may have a transceiver having multiple RF front ends coupled to multiple power amplifiers and the power amplifiers being coupled to multiple antennas. The wireless terminal 106 can include a transmitter 168 coupled to the transceiver 155. In a typical digital signal processing based implementation, the transmitter module may be a piece of software (i.e., a DSP module) that performs the function of digital computation. The wireless terminal 106 can include a controller 160 coupled to the transceiver 155. The controller 160 can be configured to control operations of the wireless terminal 106.

Conventionally a single transceiver with a single RF front end is connected to a single PA which is connected to a single antenna at a wireless terminal in uplink transmission. With multiple physical antennas at the UE, there are different multi-antenna uplink transmission modes. The term transmission mode refers to a particular configuration of elements used in the transmission of a communications signal and interaction among elements. The uplink transmission modes that can be supported depend on implementation architecture. For example, if the transceiver has a single RF front end but multiple antennas, the UE can transmit from the best antennas adaptively—an operation mode referred to as transmit antenna switching. In the case of a transceiver with multiple front ends coupled to different power amplifiers and different antennas, there are more options for transmission which can be divided into roughly two major categories of schemes: open-loop modes and closed-loop modes. Open-loop modes of operation refer to techniques that do not require the receiver to tell the transmitter any information of the channel experienced in uplink transmission. Closed-loop modes of operation refer to techniques that require the receiver to convey some information about the channel. Based on this channel information, the transmitter typical weights the signal to be sent on each antenna by a complex-valued coefficient so that, as an example of transmission strategies, maximal amount of signal can be directed to the receiver. This processing is referred to as precoding or beamforming. In both open- or closed-loop modes of operation, the transmitted signals from multiple antennas may correspond to a single stream of data (i.e., single-layer or rank-1) or multiple streams of data (i.e., multi-layer or rank-x).

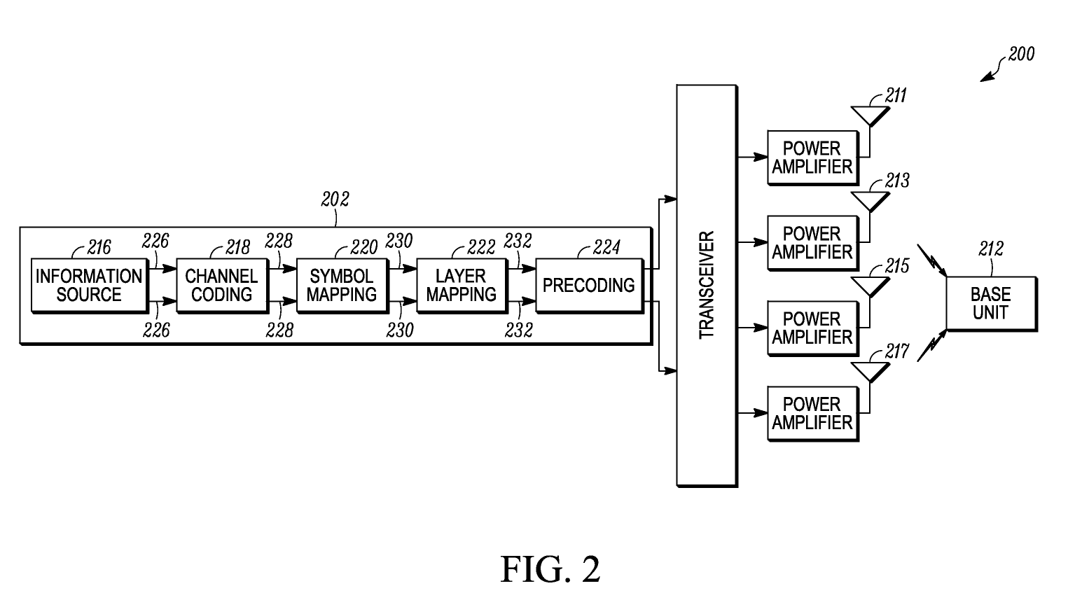

An example of two-layer or two-stream closed-loop transmission is shown in FIG. 2 where a wireless terminal can transmit to a base unit 212 from transmit antennas 211, 213, 215 and 217. The uplink communication signal corresponding to each stream or layer, may consist of an information-bearing signal as well as reference signals which may be used by the base unit 212 for determining the effective uplink channel corresponding to that data stream. The effective channel is the precoded channel as will be explained later, based on the uplink channels that can be represented as vectors with the i^{th} element of the vector representing the physical channel between the i^{th} transmit antenna at wireless terminal and an antenna at the base unit 212. The channels may be represented in multiple forms. For example, one form is the complex-valued transfer function H(f) as a function of frequency f. Channels 208 and 210 may therefore be represented as a vector of transfer functions:

[H₁^{UL}(f)H₂^{UL}(f)H₃^{UL}(f)H₄^{UL}(f)]^{T}

The notation [•]^{T} denotes the transpose of a vector. It is known by those skilled in the art that representations other than the transfer function may be used to describe a channel.

The transmitter 202 of the wireless terminal can include an information source 216 which generates N_{TB} transport blocks (TBs) 226 containing information to be transmitted to the base unit 212. There may be one TB (N_{TB}=1) or up to M TBs with M being the number of antenna at the wireless terminal. Each of the transport blocks 226 can be encoded at a channel coding block 218 separately to form codewords 228 which can include coded bits. Channel coding may be performed with turbo coding, convolutional coding, or block coding. The symbol mapping block 220 can then maps each codeword 228 to a block of complex-valued symbols 230. Symbol mapping can be performed by taking sets of bits from each of the N_{TB} codewords 228 and forming a complex-valued symbol according to a mapping rule. For example the quadrature phase-shift keying (QPSK) mapping rule maps two bits to a complex-valued symbol.

Other mapping rules which map sets of coded bits to quadrature amplitude modulation (QAM) symbols may also be used. The N_{TB} blocks of complex-valued symbols can then be fed to the layer mapping block 222 which can map complex-valued symbols to a set of N layer-mapped output block 232. Note that the layer mapping block 222 can be bypassed in the case of single-layer uplink transmission. A data stream herein is referred to as a data layer and the term “layer” and “stream” may be used interchangeably.

The layer-mapped blocks 232 are then fed to the precoding function 224 which can generate the inputs to the M wireless terminal antennas 211, 213, 215, and 217 (for the case of M=4), coupled through the transceiver(s) and power amplifiers. In a closed-loop mode, precoding 224 can be performed with a precoding matrix which is used to form multiple weighted-combinations of the transmitter outputs. The weighted combinations are then applied to the transmit antennas. Taking N=2 and M=4 and denoting the k^{th} symbols of the layer-mapped blocks as s₁(k) and s₂(k) and the antenna inputs as x₁(k) and x₂(k), the precoding operation can be written as:

$$[ \begin{matrix}{x}_{1} ( k ) \\ {x}_{2} ( k ) \\ {x}_{3} ( k ) \\ {x}_{4} ( k )\end{matrix} ] = P [ \begin{matrix}{s}_{1} ( k ) \\ {s}_{2} ( k )\end{matrix} ]$$

where P is a 4×2 precoding matrix with complex-valued entries. In this way, precoding operation can be represented mathematically by a vector of complex-valued weightings applied onto the transmission waveform of each antenna. When the user transmits multiple data streams, each stream will have its own precoding vector, resulting in a precoding matrix with each column being the precoding vector for each stream.

A precoding matrix index (PMI), selected from a pre-defined set of matrices (i.e., codebook) known to the UE, can be signalled by the eNB dynamically. PMI, along with the associated transmission parameters, may be determined by the base unit that conveys the selected PMI to the UE via control signaling, typically as part of the uplink resource allocation information. The transmission parameters associated with the selected PMI include modulation and coding schemes for each data layer, power to be used for each layer, and many more. The eNB may base its PMI decision and associated parameters on the uplink channel observed from a reference signal sent by the wireless terminal. The UE may also assist the decision making based on some measured characteristics of the multiple antennas at the UE side.

One scheme for transmitting multiple streams is to divide the transmission antennas into non-overlapping subsets or groups of antennas with each subset serving one stream. Since there is only one stream sent from each antenna, i.e., the signal driving each PA is not a combination of waveforms, and therefore the peak-to-average-power-ratio (PAPR) or constant-modulus (CM) property of the driving waveform remains unchanged regardless of the number of streams, which allows the PA efficiency to be maintained regardless of the number of streams.

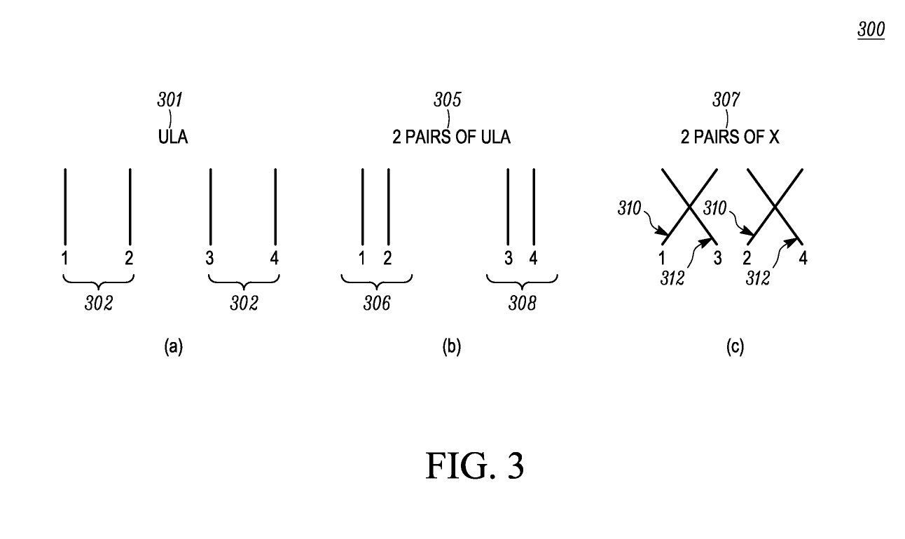

FIG. 3 illustrates possible ways of grouping transmit antenna elements, using 4 transmit antenna as an example. A 4-Tx user device can have any of the following typical antenna configurations.

a) Uniform Linear Array (ULA) configuration 301 with small or large spacing, where the four transmit antenna can be divided into two groups for example, with antenna #1 and #2 in group-302 and antenna #3 and #4 in group-304.

b) 2 pair of ULA configuration 305 with small intra-group spacing and large inter-group spacing, where the four transmit antenna can be divided into two groups for example, with antenna #1 and #2 in group-306 and antenna #3 and #4 in group-308.

c) 2 pair of cross-polarized antenna configuration 307 with small or large spacing, where the four transmit antenna can be divided into two groups for example, with co-polarized antenna #1 and #2 in group-310 and co-polarized antenna #3 and #4 in group-312.

When such grouping-based precoding codebook is designed, it is possible to construct the codebook based on a smaller codebook designed for the group size of the subset of antennas. Several properties of a grouping-based codebook are desirable:

1. Encompasses all possible ways of antenna grouping if possible

2. The intra-grouping precoding codebook should encompass all the possible precoding vectors allowed in the codebook defined for the group size.

3. If possible, there should be no constraint on the intra-group precoding imposed by the precoding used in another group (i.e., inter-group independency)

Based on grouping, a simple 4-Tx codebook can be constructed based on a size-4 2-Tx codebook defined as

$${C}_{2 Tx} = \{ [ \begin{matrix}1 \\ 1\end{matrix} ] , [ \begin{matrix}1 \\ - 1\end{matrix} ] , [ \begin{matrix}1 \\ j\end{matrix} ] [ \begin{matrix}1 \\ - j\end{matrix} ] \} .$$

Such a 2-Tx codebook as defined in 3GPP LTE Rel-8 for rank-1 (i.e., a single stream) can also be expressed a bit more succinctly as

$${C}_{2 Tx} = \{ [ \begin{matrix}1 \\ x\end{matrix} ] \} , x ∈ \{ 1 , - 1 , j , - j \} .$$

Assuming grouping of (1,2) and (3,4) and designing a codebook for 2 data streams or rank-2, one possible design of size-16 that can meet design property #2 and #3 is just the cross-product of two 2-Tx codebook, which can be written as:

$${C}_{4 Tx} = \{ [ \begin{matrix}1 & 0 \\ x & 0 \\ 0 & 1 \\ 0 & y\end{matrix} ] \} , x , y ∈ \{ 1 , - 1 , j , - j \} .$$

Expanding out the above codebook, we have

C_{4Tx}={c(m, n)} m: row index, n: column index

$$[ \begin{matrix}1 & 0 \\ 1 & 0 \\ 0 & 1 \\ 0 & 1\end{matrix} ] , [ \begin{matrix}1 & 0 \\ 1 & 0 \\ 0 & 1 \\ 0 & - 1\end{matrix} ] , [ \begin{matrix}1 & 0 \\ 1 & 0 \\ 0 & 1 \\ 0 & j\end{matrix} ] , [ \begin{matrix}1 & 0 \\ 1 & 0 \\ 0 & 1 \\ 0 & - j\end{matrix} ] , [ \begin{matrix}1 & 0 \\ - 1 & 0 \\ 0 & 1 \\ 0 & 1\end{matrix} ] , [ \begin{matrix}1 & 0 \\ - 1 & 0 \\ 0 & 1 \\ 0 & - 1\end{matrix} ] , \\ [ \begin{matrix}1 & 0 \\ - 1 & 0 \\ 0 & 1 \\ 0 & j\end{matrix} ] , [ \begin{matrix}1 & 0 \\ - 1 & 0 \\ 0 & 1 \\ 0 & - j\end{matrix} ] , [ \begin{matrix}1 & 0 \\ j & 0 \\ 0 & 1 \\ 0 & 1\end{matrix} ] , [ \begin{matrix}1 & 0 \\ j & 0 \\ 0 & 1 \\ 0 & - 1\end{matrix} ] , [ \begin{matrix}1 & 0 \\ j & 0 \\ 0 & 1 \\ 0 & j\end{matrix} ] , [ \begin{matrix}1 & 0 \\ j & 0 \\ 0 & 1 \\ 0 & - j\end{matrix} ] , \\ [ \begin{matrix}1 & 0 \\ - j & 0 \\ 0 & 1 \\ 0 & 1\end{matrix} ] , [ \begin{matrix}1 & 0 \\ - j & 0 \\ 0 & 1 \\ 0 & - 1\end{matrix} ] , [ \begin{matrix}1 & 0 \\ - j & 0 \\ 0 & 1 \\ 0 & j\end{matrix} ] , [ \begin{matrix}1 & 0 \\ - j & 0 \\ 0 & 1 \\ 0 & - j\end{matrix} ] .$$

It has to be mentioned that one column or multiple columns of the precoding matrix defined in C4Tx can be scaled (i.e., multiplied) by one or more scalars without affecting the performance. In other words, the codebook C_{4Tx} is a special case of the following more generic codebook

$${C}_{4 Tx} = \{ [ \begin{matrix}a ( \begin{matrix}1 \\ x\end{matrix} ) & \begin{matrix}0 \\ 0\end{matrix} \\ \begin{matrix}0 \\ 0\end{matrix} & b ( \begin{matrix}1 \\ y\end{matrix} )\end{matrix} ] \} , x , y ∈ \{ 1 , - 1 , j , - j \} , a , b \text{:} any scalar$$

In general, the scaling factor is a value of amplitude one, including one itself.

The advantage of the above codebook is that the first and second precoding vectors do not depend on each other. Any vector in the intra-group precoding codebook may be used for the second precoding vector regardless of the precoding vector in the intra-group precoding codebook used for the first precoding vector. In other words, for either the first or second group, any vector in the intra-group precoding codebook may be used as the intra-group precoding vector independently from the other group. The intra-group precoding codebook in the example here is the codebook C_{2Tx} designed for 2-Tx antennas.

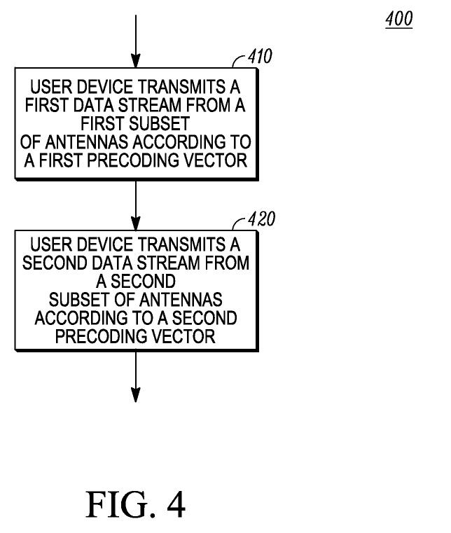

FIG. 4 illustrates a flow chart for a preferred embodiment of the invention. In 410, a user device in its uplink transmission transmits a first data stream from a first subset of transmit antennas according to a first precoding vector, wherein the first precoding vector may be any of the vectors in a precoding codebook. In 420, the user device transmits a second data stream from a second subset of the transmit antennas according to a second precoding vector, wherein any vector in the precoding codebook C_{2Tx} may be used for the second precoding vector when the second precoding vector is the same as the first precoding vector to within a scaling factor.

With the above 4-Tx codebook example, a user device with four transmit antennas can transmit a first data stream from a first subset of two transmit antennas according to a first precoding vector, wherein the first precoding vector may be any of the 4 vectors in the precoding codebook C_{2Tx}. The user device transmits a second data stream from a second subset of two transmit antennas according to a second precoding vector, wherein any of the 4 vectors in the precoding codebook C_{2Tx} may be used for the second precoding vector when the second precoding vector is the same as the first precoding vector to a scaling factor.

In other words, the second precoding vector and the first precoding vector can be the same to a scaling factor, as shown in c(1,1), c(2,2), c(3,3), and c(4,4), which represents all the 4 possible vectors allowed in the precoding codebook C_{2Tx}.

In the above example, the first and second subset of transmit antennas are non-overlapping and have the same size of 2.

The above codebook assume a particular grouping of antenna (1,2) as the first subset and (3,4) as the second subset. To accommodate all the possible ways of grouping, i.e., (1,2)+(3,4), (1,3)+(2,4), (1,4)+(2,3), a size-48 (16×3) codebook is needed, which means a larger number of bits to represent the PMI. To reduce the overhead associated with PMI, one could pre-determine the grouping or signal it semi-statically only when the antennas need to be re-grouped due to, for example, a change in the antenna correlation.

In the case that some precoding matrices must be dropped to reduce the size of a codebook for a given grouping scenario, the first and second precoding vectors may not be independent from each other. In other words, not all the combinations of intra-group precoding as defined in C4Tx are permitted. At least a vector in the precoding codebook cannot be used for the second precoding vector when a certain precoding vector in the precoding codebook is used for the first precoding vector. An arbitrary example of a size-16 4-Tx codebook is shown below where eight matrices in C4Tx are dropped to make room to accommodate other possibilities of grouping in addition to (1,2) and (3,4).

D_{4Tx}={D(m,n)} m: row index n: column index

$$[ \begin{matrix}1 & 0 \\ 1 & 0 \\ 0 & 1 \\ 0 & - j\end{matrix} ] , [ \begin{matrix}1 & 0 \\ 1 & 0 \\ 0 & 1 \\ 0 & j\end{matrix} ] , [ \begin{matrix}1 & 0 \\ - j & 0 \\ 0 & 1 \\ 0 & 1\end{matrix} ] , [ \begin{matrix}1 & 0 \\ - j & 0 \\ 0 & 1 \\ 0 & - 1\end{matrix} ] , [ \begin{matrix}1 & 0 \\ - 1 & 0 \\ 0 & 1 \\ 0 & - j\end{matrix} ] , [ \begin{matrix}1 & 0 \\ - 1 & 0 \\ 0 & 1 \\ 0 & j\end{matrix} ] , \\ [ \begin{matrix}1 & 0 \\ j & 0 \\ 0 & 1 \\ 0 & 1\end{matrix} ] , [ \begin{matrix}1 & 0 \\ j & 0 \\ 0 & 1 \\ 0 & - 1\end{matrix} ] , [ \begin{matrix}1 & 0 \\ 0 & 1 \\ 1 & 0 \\ 0 & 1\end{matrix} ] , [ \begin{matrix}1 & 0 \\ 0 & 1 \\ 1 & 0 \\ 0 & - 1\end{matrix} ] , [ \begin{matrix}1 & 0 \\ 0 & 1 \\ - 1 & 0 \\ 0 & 1\end{matrix} ] , [ \begin{matrix}1 & 0 \\ 0 & 1 \\ - 1 & 0 \\ 0 & - 1\end{matrix} ] , \\ [ \begin{matrix}1 & 0 \\ 0 & 1 \\ 0 & 1 \\ 1 & 0\end{matrix} ] , [ \begin{matrix}1 & 0 \\ 0 & 1 \\ 0 & - 1 \\ 1 & 0\end{matrix} ] , [ \begin{matrix}1 & 0 \\ 0 & 1 \\ 0 & 1 \\ - 1 & 0\end{matrix} ] , [ \begin{matrix}1 & 0 \\ 0 & 1 \\ 0 & 1 \\ - 1 & 0\end{matrix} ]$$

For grouping (1,2) and (3,4) where 8 matrices are allowed, rather than 16 in C_{4Tx}. Therefore, at least some vectors in the precoding codebook C_{2Tx} cannot be used for the second precoding vector when a certain precoding vector in the precoding codebook C_{4Tx} is used for the first precoding vector. For example, when the first precoding vector uses [1,1], the second precoding vector cannot use [1,1] or [1,−1].

It can be observed from the typical antenna configurations in FIG. 3 b) and c) that the intra-group antenna correlation is the same statistically given the symmetry between groups. Hence the intra-group precoding (i.e., the first and second precoding vector) will most likely be the same statistically. Therefore, it is important to allow the second precoding vector to be the same as the first precoding vector to within a scaling factor, and at the same time, any vector in the precoding codebook C_{2Tx} may be used for the second precoding vector (in this case also the first precoding vector). In the above example of 4-Tx precoding, that means it is important to include, in any 4-Tx codebook with a reduced size, at least the four matrices defined as

$${T}_{4 Tx} = \{ [ \begin{matrix}a ( \begin{matrix}1 \\ x\end{matrix} ) & \begin{matrix}0 \\ 0\end{matrix} \\ \begin{matrix}0 \\ 0\end{matrix} & b ( \begin{matrix}1 \\ x\end{matrix} )\end{matrix} ] \} , x ∈ \{ 1 , - 1 , j , - j \} , a , b are any scalar$$

Observing the codebook D_{4TX}, unfortunately none of the four matrices as in T_{4TX} is included for grouping scenario of (1,2) and (3,4). For grouping (1,3) and (2,4), the same precoding vectors are used in D(3,1) and D(3,4). However, some vectors in the precoding codebook C_{2Tx} cannot be used for the second precoding vector when the second precoding vector is the same as the first precoding vector to a scaling factor. Following the principle that any vector in the precoding codebook should be allowed for the second precoding vector when the second precoding vector is the same as the first precoding vector to a scaling factor, one can modify D_{4TX} by replacing some matrices with the following matrices:

$$[ \begin{matrix}1 & 0 \\ 1 & 0 \\ 0 & 1 \\ 0 & 1\end{matrix} ] , [ \begin{matrix}1 & 0 \\ - 1 & 0 \\ 0 & 1 \\ 0 & - 1\end{matrix} ] , [ \begin{matrix}1 & 0 \\ j & 0 \\ 0 & 1 \\ 0 & j\end{matrix} ] , [ \begin{matrix}1 & 0 \\ - j & 0 \\ 0 & 1 \\ 0 & j\end{matrix} ] , \\ [ \begin{matrix}1 & 0 \\ 0 & 1 \\ 1 & 0 \\ 0 & 1\end{matrix} ] , [ \begin{matrix}1 & 0 \\ 0 & 1 \\ - 1 & 0 \\ 0 & - 1\end{matrix} ] , [ \begin{matrix}1 & 0 \\ 0 & 1 \\ j & 0 \\ 0 & j\end{matrix} ] , [ \begin{matrix}1 & 0 \\ 0 & 1 \\ - j & 0 \\ 0 & - j\end{matrix} ] , \\ [ \begin{matrix}1 & 0 \\ 0 & 1 \\ 0 & 1 \\ 1 & 0\end{matrix} ] , [ \begin{matrix}1 & 0 \\ 0 & 1 \\ 0 & - 1 \\ - 1 & 0\end{matrix} ] , [ \begin{matrix}1 & 0 \\ 0 & 1 \\ 0 & j \\ j & 0\end{matrix} ] , [ \begin{matrix}1 & 0 \\ 0 & 1 \\ 0 & - j \\ - j & 0\end{matrix} ]$$

It can be seen that the user device with a plurality of transmit antennas transmits a first data stream from a first subset of the plurality of transmit antennas according to a first precoding vector, wherein at any time instant the first precoding vector is one of a first set of precoding vectors in a precoding codebook. The user device transmits a second data stream from a second subset of the plurality of transmit antennas according to a second precoding vector, wherein at a plurality of time instants the second precoding vector is one of a second set of precoding vectors in the precoding codebook, wherein at each of the plurality of time instants the second precoding vector is the same as the first precoding vector to a scaling factor and at each of the plurality of time instants the first set of precoding vectors is the same as the second set of precoding vectors to a scaling factor.

In one embodiment as illustrated from the above discussion with 4-Tx precoding based on antenna grouping, there are only two data streams.

In another embodiment, the above principle can be extended to more than two data streams, as long as there are two data streams using two different subsets of antennas. In this case, the rank-2 (or 2-stream) precoding matrix can be a sub-matrix of the rank-3 precoding matrix. An example design is shown here:

$$[ \begin{matrix}1 & 1 & \\ 1 & - 1 & \\ 1 & & 1 \\ - 1 & & 1\end{matrix} ] , [ \begin{matrix}1 & 1 & \\ 1 & - 1 & \\ j & & j \\ j & & - j\end{matrix} ] , [ \begin{matrix}1 & 1 & \\ 1 & - 1 & \\ - 1 & & - 1 \\ 1 & & - 1\end{matrix} ] , [ \begin{matrix}1 & 1 & \\ 1 & - 1 & \\ - j & & - j \\ - j & & j\end{matrix} ] , \\ [ \begin{matrix}1 & 1 & \\ j & - j & \\ 1 & & 1 \\ j & & - j\end{matrix} ] , [ \begin{matrix}1 & 1 & \\ j & - j & \\ j & & j \\ 1 & & - 1\end{matrix} ] , [ \begin{matrix}1 & 1 & \\ j & - j & \\ - 1 & & - 1 \\ - j & & j\end{matrix} ] , [ \begin{matrix}1 & 1 & \\ j & - j & \\ - j & & - j \\ - 1 & & 1\end{matrix} ] , \\ [ \begin{matrix}1 & 1 & \\ - 1 & 1 & \\ 1 & & 1 \\ 1 & & - 1\end{matrix} ] , [ \begin{matrix}1 & 1 & \\ - 1 & 1 & \\ j & & j \\ - j & & j\end{matrix} ] , [ \begin{matrix}1 & 1 & \\ - 1 & 1 & \\ - 1 & & - 1 \\ - 1 & & 1\end{matrix} ] , [ \begin{matrix}1 & 1 & \\ j & - j & \\ - j & & - j \\ - 1 & & 1\end{matrix} ] , \\ [ \begin{matrix}1 & 1 & \\ - j & j & \\ 1 & & 1 \\ - j & & j\end{matrix} ] , [ \begin{matrix}1 & 1 & \\ - j & j & \\ j & & j \\ - 1 & & 1\end{matrix} ] , [ \begin{matrix}1 & 1 & \\ - j & j & \\ - 1 & & - 1 \\ j & & - j\end{matrix} ] , [ \begin{matrix}1 & 1 & \\ - j & j & \\ - j & & - j \\ 1 & & - 1\end{matrix} ]$$

This design assumes a first subset of antennas (i.e., 1,2) are used for transmitting a first data stream (i.e., stream-2) and a second subset of antennas (i.e., 3,4) are used for transmitting a second stream (i.e., stream-3). A third stream is sent from all 4 antennas. The intra-group precoding for the first stream (stream-2) clearly can be any precoding vector in C_{2Tx}. Any vector in the precoding codebook C_{2Tx} may be used for the second precoding vector when the second precoding vector is the same as the first precoding vector to a scaling factor. In fact, for each precoding vector (i.e., [1,x] for the first stream (stream-2), there are two precoding vectors that are the same as the first precoding vector for the second stream (stream-3), even though that they are the same up to a scaling factor.

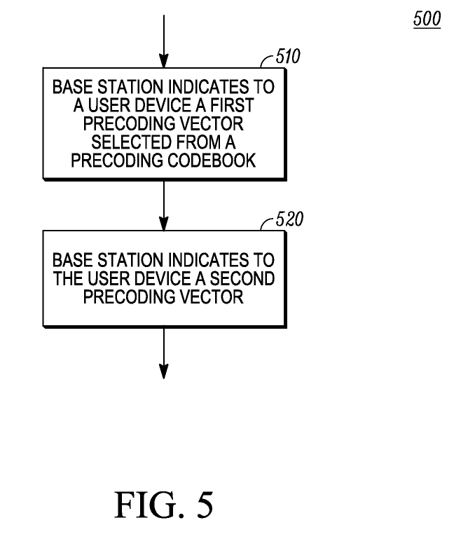

FIG. 5 illustrates another preferred embodiment of the invention. In 510, a base station indicates to a user device a first precoding vector selected from a precoding codebook, wherein the first precoding vector is for a first subset of a plurality transmit antennas of the user device; In 520, the base station indicates to the user device a second precoding vector, wherein the second precoding vector is for a second subset of a plurality transmit antennas of the user device; and wherein any vector in the precoding codebook may be used for the second precoding vector when the second precoding vector is the same as the first precoding vector to a scaling factor.

While the above invention is described from the uplink perspective from a user device to a base station. The principle set forth can be easily applied to downlink.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method for performing uplink transmission in a user device with a plurality of transmit antennas, the method comprising:
transmitting a first data stream from a first subset of the plurality of transmit antennas according to a first precoding vector, wherein the first precoding vector may be any vector in a precoding codebook;
transmitting a second data stream from a second subset of the plurality of transmit antennas according to a second precoding vector,
wherein any vector in the precoding codebook may be used for the second precoding vector when the second precoding vector is the same as the first precoding vector to a scaling factor.

2. The method of claim 1, wherein any vector in the precoding codebook may be used when the first precoding vector is different than the second precoding vector.

3. The method according to claim 1, wherein the first subset of the plurality of transmit antennas and the second subset of the plurality of the transmit antennas are non-overlapping and are of the same size.

4. The method according to claim 1,
wherein transmitting the first data stream from the first subset of antennas according to the first precoding vector is by weighting the first data stream with the entries of the first precoding vector on each corresponding antenna in the first subset, and
wherein transmitting the second data stream from the second subset of antennas according to the second precoding vector is by weighting the second data stream with the entries of the second precoding vector on each corresponding antenna in the second subset.

5. The method according to claim 1, wherein the scaling factor is any complex number of magnitude one, including the value of one.

6. The method according to claim 1, wherein any vector in the precoding codebook may be used for the second precoding vector regardless of the precoding vector in the precoding codebook used for the first precoding vector.

7. The method according to claim 1, wherein at least a vector in the precoding codebook cannot be used for the second precoding vector when a certain precoding vector in the precoding codebook is used for the first precoding vector.

8. The method according to claim 1 further comprising the user device receiving an indication from a base station of the first precoding vector and the second precoding vector.

9. The method according to claim 1, wherein the precoding codebook is defined for a number of antennas in the first subset and the precoding codebook is known to the user device.

10. The method according to claim 1, wherein there are only two data streams to be sent from the user device.

11. A method for performing uplink transmission in a user device with a plurality of transmit antennas, the method comprising:
transmitting a first data stream from a first subset of the plurality of transmit antennas according to a first precoding vector, wherein at any time instant the first precoding vector is one of a first set of precoding vectors in a precoding codebook;
transmitting a second data stream from a second subset of the plurality of transmit antennas according to a second precoding vector, wherein at a plurality of time instants the second precoding vector is one of a second set of precoding vectors in the precoding codebook,
wherein at each of the plurality of time instants the second precoding vector is the same as the first precoding vector to a scaling factor and at each of the plurality of time instants the first set of precoding vectors is the same as the second set of precoding vectors to a scaling factor.

12. The method according to claim 10, wherein the first set of precodings vectors in a precoding codebook includes all vectors in the precoding codebook.

13. A method in a base station, the method comprising:
indicating to a user device a first precoding vector selected from a precoding codebook, wherein the first precoding vector is for a first subset of a plurality transmit antennas of the user device;
indicating to the user device a second precoding vector, wherein the second precoding vector is for a second subset of a plurality transmit antennas of the user device,
wherein any vector in the precoding codebook may be used for the second precoding vector when the second precoding vector is the same as the first precoding vector to a scaling factor.

14. The method according to claim 13, wherein the first subset of the plurality of antennas and the second subset of the plurality of the antennas are non-overlapping and have a common size.

15. The method according to claim 13, wherein the scaling factor is any complex number of one, including the value one itself.

16. The method according to claim 13, wherein any vector in the precoding codebook may be used for the second precoding vector regardless of the first precoding vector selected from the precoding codebook.

17. The method according to claim 13, wherein at least a vector in the precoding codebook cannot be used for the second precoding vector when a certain precoding vector in the precoding codebook is used for the first precoding vector.

18. A wireless terminal comprising:
a plurality of transmit antennas;
a plurality of transceivers coupled to the plurality of transmit antennas;
a precoding module coupled to the plurality of transceivers,
the precoding module weights a first data stream according to a first precoding vector, wherein the first data stream is transmitted from a first subset of transmit antennas and the first precoding vector may be any vector in a precoding codebook,
the precoding module weights a second data stream according to a second precoding vector, wherein the second data stream is transmitted from a second subset of transmit antennas and wherein any vector in the precoding codebook may be used for the second precoding vector when the second precoding vector is the same as the first precoding vector to a scaling factor.

19. The wireless terminal according to claim 17, wherein the first subset of the plurality of antennas and the second subset of the plurality of the antennas are non-overlapping and have a common size.

20. The wireless terminal according to claim 18, wherein the scaling factor is any complex number of magnitude one, including the value one itself.

21. The wireless terminal according to claim 17, wherein any vector in the precoding codebook may be used for the second precoding vector regardless of the precoding vector in the precoding codebook being used for the first precoding vector.

22. The wireless terminal according to claim 17, wherein at least a vector in the precoding codebook cannot be used for the second precoding vector when a certain precoding vector in the precoding codebook is used for the first precoding vector.
